(19) United States
(12) Patent Application Publication
(10) Pub. No.: US 2015/0319080 A1
(43) Pub. Date: Nov. 5, 2015

(54) BASIC SELF-ROUTING UNIT AND METHOD FOR BUILDING ITS HALF-CLEANERS, SORTERS, NETWORK CONCENTRATORS AND MULTICAST SWITCHING NETWORK

(71) Applicants: PEKING UNIVERSITY SHENZHEN GRADUATE SCHOOL, Shenzhen (CN); SHENZHEN LI DE JIA INDUSTRIAL CO., LTD., Shenzhen (CN)

(72) Inventors: Hui LI, Shenzhen (CN); Shuoyan LI, Shenzhen (CN); Fuxing CHEN, Shenzhen (CN); Zhipu ZHU, Shenzhen (CN); Kai CUI, Shenzhen (CN)

(21) Appl. No.: 14/711,802

(22) Filed: May 14, 2015

Related U.S. Application Data
(63) Continuation-in-part of application No. PCT/CN2012/085793, filed on Dec. 4, 2012.

(51) Int. Cl. H04L 12/761; H04L 12/741; H04L 12/801

(52) U.S. Cl. CPC H04L 45/16; H04L 47/12; H04L 45/54

(57) ABSTRACT

The invention relates to a basic self-routing unit for multicast. The basic self-routing unit includes two input ports and two output ports. The input signal of the input ports includes the route signal and the following data priority control section and data content. The route signal has an algebraic lattice structure. The route signal includes a bicast signal, a unicast signal and an idle signal. When the route signals of the two input ports are the bicast signal and the idle signal respectively, the output value of the first output port is a Boolean product of the two input route signals and the output value of the second output port is a Boolean sum of the two input route signals. The invention relates to the use of a concentrator built by the basic self-routing unit and its network-forming method.

### CROSS-REFERENCE TO RELATED APPLICATIONS

This application is a continuation-in-part of International Patent Application No. PCT/CN2012/085793 with an international filing date of Dec. 4, 2012, designating the United States, now pending, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND OF THE INVENTION

1. Field of the Invention

The invention relates to a communication network, in particular to a basic self-routing unit and a method for building its half-cleaners, sorters, network concentrators and multicast switching network.

2. Description of the Related Art

In recent years, network service has been greatly popularized. Online video service is one of the services that are used the most. Video streaming has typical characteristics, such as, video content is sent from a single point and received at multiple points, which is commonly referred to as multicast. At present, the flow of popular applications based on video application such as IPTV, video conferences, interactive simulation and multiplayer games all have the characteristics of multicast. Therefore, in order to improve the performance and effective utilization of network, multicast communication technology is of particular importance.

In order to realize the characteristics of multicast, the early internet adopted the method of repeated unicast transmission. The strategy of repeated unicast not only increases server workload but also increases the network flow. If the IP multicast technology is adopted to establish a forwarding tree between one sender and a plurality of receivers through the multicast protocol, the sender only needs to transmit one piece of data content which can be copied through the intermediate route switching nodes and finally transmit the copies to all receivers, so that the server workload and the network load can be reduced fundamentally.

Focus of research in the field of IP multicast has inclined towards flow control and congestion control, research on wireless multicast and research on large-scale high-effective multicast.

Although the realization of multicast needs the support of an application layer, a transmission layer, a network layer and a data link layer in the network, from a realized physical location, it can be divided into terminals and intermediate route switching nodes; and from a realization method, it can be divided into a method of a repeated unicast software scheduling and a method of a hardware circuit wire speed fan-out copy. However, as a whole, the terminals basically realize various application layers, transmission control layers and network layer protocols through software, usually without bottlenecks. And the realization of switching nodes is the key of multicast performance, because: firstly, the packet can go through route nodes of a plurality of hops (for example, 5 hops and 8 hops) but only goes through the single-hop terminal; and secondly, route nodes need to handle the contention of many ports which are the network bottleneck themselves.

The methods for realizing multicast of route switching nodes can be divided into a method of a repeated unicast software scheduling and a method of a hardware circuit wire speed fan-out copy. The reference Ying Liu and Ke Xu; Internet Multicast System Architecture, Science Press, April 2008 says that most of the current multicast based on switching nodes is soft multicast of repeated unicast; that is to say, the multicast packet is copied first before the route, then the copies line up in their respective source port queue, and then the packet transmission is achieved through software to realize the respective scheduling mode of port matching. At present, an overwhelming majority of routes of Cisco (William R. Parkhurst; Cisco multicast routing and switching, McGraw-Hill, 1999) and Huawei have realized the PIM-SM multicast route protocol and the IGMP, and has the capability of supporting multicast business. Nevertheless, soft multicast has a disadvantage of poor real-time performance and cannot ensure quality. This method makes the multicast data packets that are transmitted to different users go through different time delays at the same node so that the jitter of receivers' data happens and the multicast performance reduces.

FIG. 1 shows a Knockout switch fabric. Knockout means knockout matches. This type of fabric comes from an obvious fact that, at the same time slot, the probability that all input cells arrive at the same port is very small. FIG. 1 is the switch fabric prototype designed on the basis of this theory; and every input port is connected to all output interface modules by adopting full join. At each output port, the address filter filters out cells whose destination addresses are not these output modules, then a N:L knockout concentrator ensures that, at the same time slot, maximum number of cells to the same port is a constant value L and the cells that exceed the value are discarded. The reference Y.-S. Yeh, M. G. Hluchyj, A. S. Acampora; “The knockout switch: A simple, modular architecture for high-performance packet switching,” IEEE Journal on Selected Areas in Communications, vol. 5, no. 8, pp. 1274-1283, October 1987 points out that, as for the independent and identically distributed unicast flow, L=12 can make the loss ratio of cells less than 10⁻¹⁰ and has nothing to do with the switch fabric scale.

Since every input port is connected with all output modules through broadcast, this architecture has characteristics of multicast. The references H. J. Chao, B. S. Choe; “Design and analysis of a large-scale multicast output buffered ATM switch,” IEEE/ACM Trans. Networking, vol. 3, pp. 126-138, April 1995, H. J. Chao, B. S. Choe, J. S. Park, N. Uzun; “Design and implementation of Abacus switch: a scalable multicast ATM switch,” IEEE J. Selected Areas Commun., vol. 15, no. 5, pp. 830-843, 1997 and K. Y. Eng, M. G. Hluchyj, Y. S. Yeh; “Multicast and Broadcast Services in a Knockout Packet Switch,” INFOCOM'88, pp. 29-34, 1988 have put forward multicast design proposals based on this architecture. FIG. 2 shows the basic architecture of MOBAS (Multicast Output Buffer ATM Switch) described in H. J. Chao, B. S. Choe; “Design and analysis of a large-scale multicast output buffered ATM switch,” IEEE/ACM Trans. Networking, vol. 3, pp. 126-138, April 1995: the architecture consists of three parts, namely the input port controller and output port controller (IPC/OPC), the multicast group network (MGN, FIG. 3) and the multicast address translation table (MTT), which is divided into two levels, namely MGN1 and MGN2 overall and logically. Due to the bus connection mode between each level and the structural characteristics of CrossBar of MGN modules, the architecture has characteristics of multicast. During the multicast cell exchange, the cell is copied in proper position at each level, and the copies are finally transmitted to the designated destination ports. Cells in every MGN module are transmitted to the desired destination output groups by self-route.

The architecture shown in FIGS. 2 and 3 effectively reduces the loss ratio of cell contention by group extension. However, the architecture is based on device complexity of CrossBar architecture Θ(N²) and the problem relates to the limitation of circuit device drive capability that the full join of interstage bus must face so that the large-scale extension of the proposal hits a bottleneck.

Tony Lee's copy network consists of three parts, namely the running sum adder network, the concentrator network and the broadcast banyan network. The running sum adder network is used to calculate the number of cells needing to be copied. As shown in FIG. 4, at the input port of the running sum adder network, every cell identifies the size of its fan-out. The calculation of the fan-out of every input port through the running sum adder network can get the number of required accumulative cells of each port of the time slot that need to be copied. Since the sum of the required multicast pocket copies at the same time slot may be larger than the number of output ports, it is necessary to refuse the port whose first accumulative sum value is larger than the number of output ports as well as cells of all ports after the port. The cells that have successfully passed the running sum adder network are encoded through the dummy address encoder to get the code of every cell output address range, and then gather at their respective neighboring ports through the concentrator network so as to meet interior nonblocking conditions of the broadcast banyan network, for example, the reference T. T. Lee; “Nonblocking copy networks for multicast packet switching”, IEEE Journal on Selected Areas in Communications, vol. 6, no. 9, pp. 1455-1467, December 1988. Finally, the Boolean interval splitting algorithm is used to copy the packet in the proper position of network nodes so as to realize functions of the copy network. And cells convert multicast addresses into corresponding unicast addresses through the multicast address conversion table and then realize the final switch through the backward stage unicast network.

Although the multicast network has provided better interior nonblocking for input cells and the self-route has the characteristic of fixed time delay, the architecture has the following problems: the running sum adder network and the dummy address encoder are not suitable for the large-scale extension; when the sum of input packet copy requirements exceeds the number of output ports, the phenomenon of overflow happens, and, if the copy network doesn't provide the retransmission mechanism, packets that exceed the number of ports will be discarded and the loss probability due to overflow will increase progressively from top to bottom in the copy network, which causes unfair services; and the cache overhead needed for the multicast address translation of the architecture is very large, and the reference Turner, J. S; “A practical version of Lee's multicast switch architecture”, IEEE Transactions on Communications, vol. 41, pp. 1166-1169, August 1993 also points out that every of its look-up tables is 256 Mb with large cache overhead. Therefore, its architecture is too complicated; the component complexity of both concentrator network and broadcast banyan network is Θ(N log₂N) which is equivalent to the complexity of the self-routing network.

Although someone has already put forward a proposal that provide a fair mechanism for the copy network, the proposal further increases the architecture complexity. The reference Turner, J. S; “A practical version of Lee's multicast switch architecture”, IEEE Transactions on Communications, vol. 41, pp. 1166-1169, August 1993 puts forward a method for reducing the multicast translation table, but it further increases the complexity of the copy network to make it difficult to expand to design of large-scale switch fabrics.

The Sunshine N. McKeown; “The iSLIP scheduling algorithm for input-queued switches,” IEEE/ACM Transactions on Networking, vol. 7, no. 2, pp. 188-201, April 1999 shown in FIG. 5 is another multicast switch fabric based on the Banyan network, the overall fabric characteristics of which is similar to that of Starlite switch which is also based on the basic frame of the Batcher-Banyan network. It increase, robustness of the overall fabric by introducing K concurrent Banyan network, the anti-burst characteristic, and the multicast capability by introducing feedback. This is a multicast copy method of cell feedback. Each input port of the network has an input port controller. But multicast cells are discovered, the cells can, through special tabs, be fed back to the input port by selector before being transmitted to the parallel Banyan network until multicast cells are all transmitted to all destination addresses. The complexity of the Batcher network O(N log₂N) in the SunShine structure itself is a bottleneck in the extension of the whole structure. Although the proposal that realizes multicast copy through feedback avoids requirements for the copy network, there are also problems like output disorder and increase of multicast cell time delay.

Due to the historical position of Clos C Clos, “A study of non-blocking switching networks”, Bell System Technical Journal, 1953 three-stage interconnection network in circuit switch as well as the component complexity (Clos is Θ(N^{1.5})) of Clos prior to that of traditional CrossBar architecture under strict non-blocking conditions, Clos attracts many scholars to study the application of Clos for packet switching. The difficulty of packet switching by application of Clos architecture is how to achieve cell switches by effective routing. This problem can be equivalently converted to the decomposition of rate matrix or the minimum edge-coloring of bipartite graph H. J. Chao, Bin Liu; High Performance Switches and Routers, John Wiley & Sons, April 2007 (P383-387). The Clos architecture is identical with conditions of unicast flow, and the key points of Clos architecture for multicast switch are the route selection and cell scheduling. Based on the Growable packet switch (GPS) (D. J. Marchok, C. E. Rohrs, R. M. Schafer; “Multicasting in a Growable Packet (ATM) Switch,” INFOCOM'91, pp. 850-858, 1991) architecture, FIG. 6 puts forward a multicast scheduling algorithm GPS and Clos are similar in the three-stage architecture, but the first two stages are the self-routing interconnection network without cache and the last stage module is a small-scale output switch module. The route in this type of architecture is mainly realized by designating the first two-stage route.

The reference D. J. Marchok, C. E. Rohrs, R. M. Schafer; “Multicasting in a Growable Packet (ATM) Switch,” INFOCOM'91, pp. 850-858, 1991 introduces a path allocation vector, which realizes multicast path allocation by reserving the path of the middle module through a ring mode in the first stage module. The algorithm is similar to an algorithm which is based on the Banyan network to resolve output contention and is set out in B. Bingham, H. Bussey; “Reservation-based contention resolution mechanism for Batcher-Banyan packet switches”, Electron Lett. 24 (13), pp 772-773, 1988. Although the algorithm is not centralized scheduling and has no bottleneck of central processing capability, the whole path decision needs to be participated in by all first stage modules in sequence. If the number of the first stage modules is k, the time complexity of the algorithm reaches Θ(K) which keeps the architecture from large-scale extension.

Many multicast path selection algorithms based on Clos have been put forward in succession. In 2010, the latest reference Jastrzebski, A., Kubale, M.; “Rearrangeability in multicast Clos networks is NP-complete”; 2nd International Conference on Information Technology (ICIT), pp. 183-186, August 2010 proved that the multicast path matching of the Clos network is a NP-complete problem. This further indicates the complexity of the Clos multicast scheduling algorithm.

To sum up, prior art all has problems of that can't carry out large-scale extension and have bottlenecks.

### SUMMARY OF THE INVENTION

In view of the above-described problems, it is one objective of the invention to provide a multicast technology that is easy to carry out large-scale extension and has no network bottlenecks, namely a basic self-routing unit and a method for building its half-cleaners, sorters, network concentrators and multicast switching network, in the light of the problems that prior art can't carry out large-scale extension and have bottlenecks.

The technical proposal of one or more embodiments to solve its technological issues is to build a basic self-routing unit for multicast. The basic self-routing unit comprises of at least two input ports and at least two output ports. The input ports includes a first input port and a second input port. The output ports includes a first output port and a second output port respectively. The input signal of the input ports comprises the route signal and the following data attribute and data content. The route signal has a algebraic lattice structure. The route signal consists of a bicast signal, a unicast signal and an idle signal. The route signals of the two input ports are the bicast signal and the idle signal respectively, the input port whose route signal is the bicast signal is connected with the first output port and the second output port respectively, the output route signal value of the first output port is the Boolean product of the two input route signals, and the output route signal value of the second output port is the Boolean sum of the two input route signals.

Further on, when the input route signals of the two input ports both point to one of the two output ports, the two input ports contend for the pointed output port according to the data priority of the data attributes of their input signals, the input port with higher data priority is connected with the output port and the input port with lower data priority is connected with the other output port; On the other hand, when the input route signals of the two input ports point to different output ports respectively, the input ports are connected with the output ports crosswise or in parallel. The cross connection includes the connection of the first input port and the second output port, and the connection of the second input port and the first output port. Similarly, the parallel connections include the connection of the first input port and the first output port, and the connection of the second input port and the second output port.

Further on, the route signals have the algebraic lattice structure, which includes using the algebraic lattice to build the self-routing in-band route signal table. The algebraic lattice is a distributive lattice.

The invention also relates to a half-cleaner constituted by the basic self-routing units. The k 2×2 bitonic sorters are arranged in order; the 2×2 bitonic sorter includes two input ports and respectively transmits the one with the smaller input signal value to the low output port and the one with the larger input signal value to the high output port. One output port of the n^{th} one of the k bitonic sorters is the n^{th} input port of the half-cleaner, and the other output port is the (k+n)^{th} input port of the half-cleaner. The low output port of the n^{th} one of the k bitonic sorters is the n^{th} output port of the half-cleaner, and its high output port is the (k+n)^{th} output port of the half-cleaner. The first output port to the k^{th} output port of the half-cleaner outputs a bitonic sequence a1, and the (k+1)^{th} output port to the 2k^{th} output port of the half-cleaner outputs a bitonic sequence a2, a1≦a2, wherein, k is a positive integer, n=1, 2, . . . , k and the 2×2 bitonic sorter is the basic self-routing unit.

Further on, when k=1, the half-cleaner is the basic self-routing unit.

The invention also relates to a bitonic sorter constituted by the self-routing units. The bitonic sorter includes G input ports and G output ports, wherein G=2^{g}, and g is a positive integer. The bitonic sorter includes g stages; among them, the m^{th} stage includes 2^{m-1} half-cleaners of k=G/2^{m}, wherein m=1, 2, . . . , g. Each stage of the half cleaners includes a plurality of 2×2 bitonic sorters, and the output port of each 2×2 bitonic sorter is respectively connected with the input ports of different 2×2 bitonic sorters of the half-cleaners of the next stage or with different half-cleaner input ports of the next stage.

The invention also relates to an arbitrary binary sorter constituted by the self-routing units. The arbitrary binary sorter includes G input ports and G output ports, wherein G=2^{g}, and g is a positive integer. The arbitrary binary sorter includes g-stage bitonic sorters, and among them, the p^{th} stage includes 2^{g-p} G×G bitonic sorters of G=2^{p}. The bitonic sorters are connected according to their stages.

The invention also relates to a network concentrator constituted by the self-routing units. The network concentrator includes 2G input ports and 2G output ports.

The network concentrator includes 2 G×G arbitrary binary sorters and half-cleaners of K=G which are connected with the output ports of the 2 G×G arbitrary binary sorters. G maximum sort output ports of the half-cleaners are a 1-output group; and G minimum sort output ports of the half-cleaners are a 0-output group.

Further on, every output port of the network concentrator is strung with an address filtering unit.

The also relates to a method for building a multicast switching network which includes the following steps:
a. building a self-routing structure network that uses a divide-and-conquer network structure with optimal layout complexity. The self-routing structure network includes a plurality of 2×2 route units and connecting wires between them.
b. using network concentrators to replace the 2×2 route units and wire harnesses with G wires to replace every connecting wires.
c. obtaining an N×N multicast switching network which has M output groups. Each group includes G output ports, wherein N represents the total number of the input/output wires of the multicast switching network, N=MG.

The basic self-routing unit and the method for building its half-cleaners, sorters, network concentrators and multicast switching network have the following advantageous effects. Its basic self-routing unit outputs the Boolean product and sum of input signals at its output ports when multicast signals appear, so as to make it not only realize unicast but also be able to realize the sorting and screening of signals during multicast. Further, half-cleaners, sorters and network concentrators may be obtained through the basic unit to realize the route switching functions of the multicast network. Therefore, the embodiments are convenient for large-scale expansion and have no network bottlenecks.

### BRIEF DESCRIPTION OF THE DRAWINGS

Embodiments are described with reference to the accompanying drawings, in which:

FIG. 1 is a structural diagram of prior art based on the Knockout switch fabric;

FIG. 2 is a structural diagram of prior art based on the MOBAS basic switch;

FIG. 3 is a structural diagram of the MNG module shown in FIG. 2;

FIG. 4 is a structural diagram of the Tony Lee copy network in prior art;

FIG. 5 is a structural diagram of another multicast switch based on the Banyan network in prior art;

FIG. 6 is a structural diagram of the multicast switch based on the Growable packet switch in prior art;

FIGS. 7A, 7B, and 7C are part status of the basic self-routing unit during unicast in accordance with one embodiment;

FIGS. 8A, 8B, 8C, 8D, 8E, 8F, 8G, and 8H are part status of the basic self-routing unit during multicast in accordance with one embodiment;

FIG. 9 is a distributive lattice status diagram as the multicast signal table in accordance with one embodiment;

FIG. 10 is a diagram of the sorting network constituted by basic self-routing units in accordance with one embodiment;

FIG. 11 is a structural diagram of the bitonic sorter in accordance with one embodiment;

FIG. 12 is a structural diagram of k half-cleaner in accordance with one embodiment;

FIGS. 13A, 13B, 13C, and 13D are state enumeration diagrams of k half-cleaner in accordance with one embodiment;

FIGS. 14A, 14B, and 14C are structural diagrams of a bitonic sorter in accordance with one embodiment;

FIGS. 15A and 15B are structural diagrams of an arbitrary binary sorter in accordance with one embodiment;

FIGS. 16A and 16B are structural diagrams of a network concentrator in accordance with one embodiment;

FIGS. 17A and 17B are state diagrams of a distributive lattice and non-distributive lattice in accordance with one embodiment;

FIGS. 18A and 18B are practical signal transmission process diagrams of a network concentrator in accordance with one embodiment; and

FIG. 19 is a network structural diagram constituted by network concentrators in accordance with one embodiment.

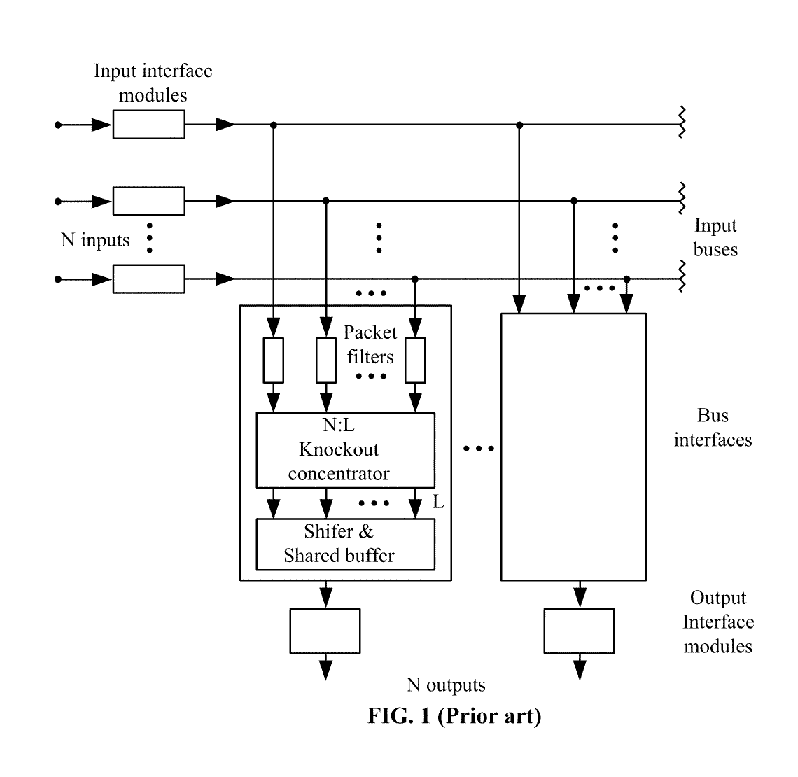

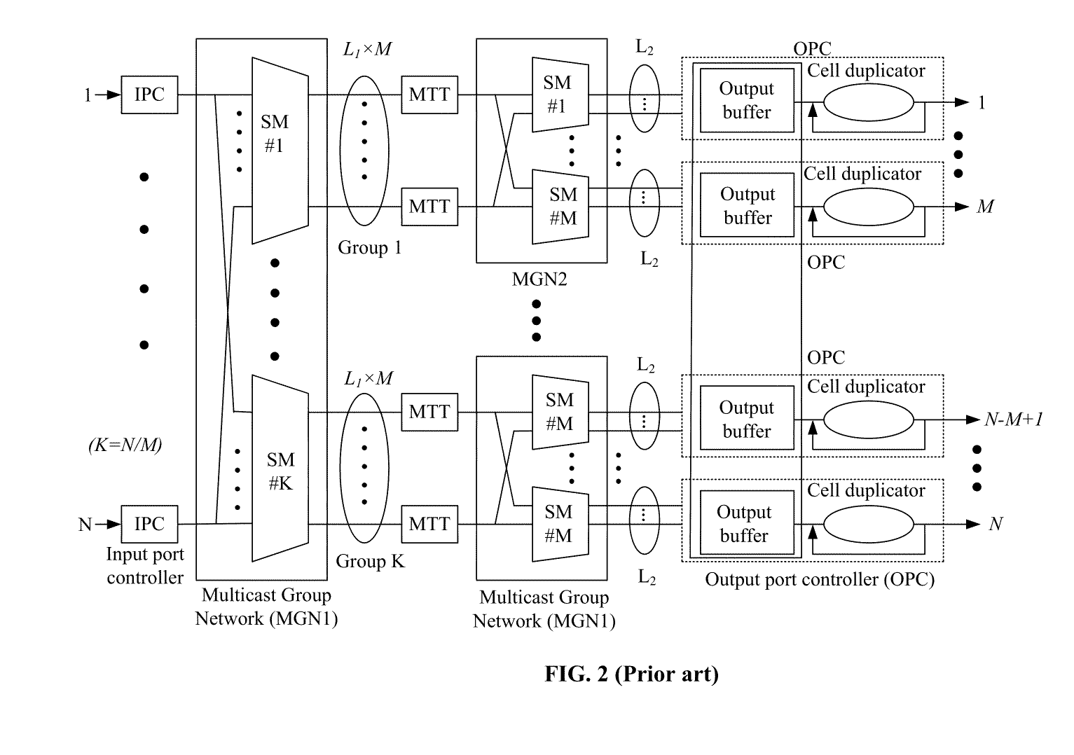

### DETAILED DESCRIPTION OF THE EMBODIMENTS

The following will further illustrate the embodiments of the invention with attached drawings.

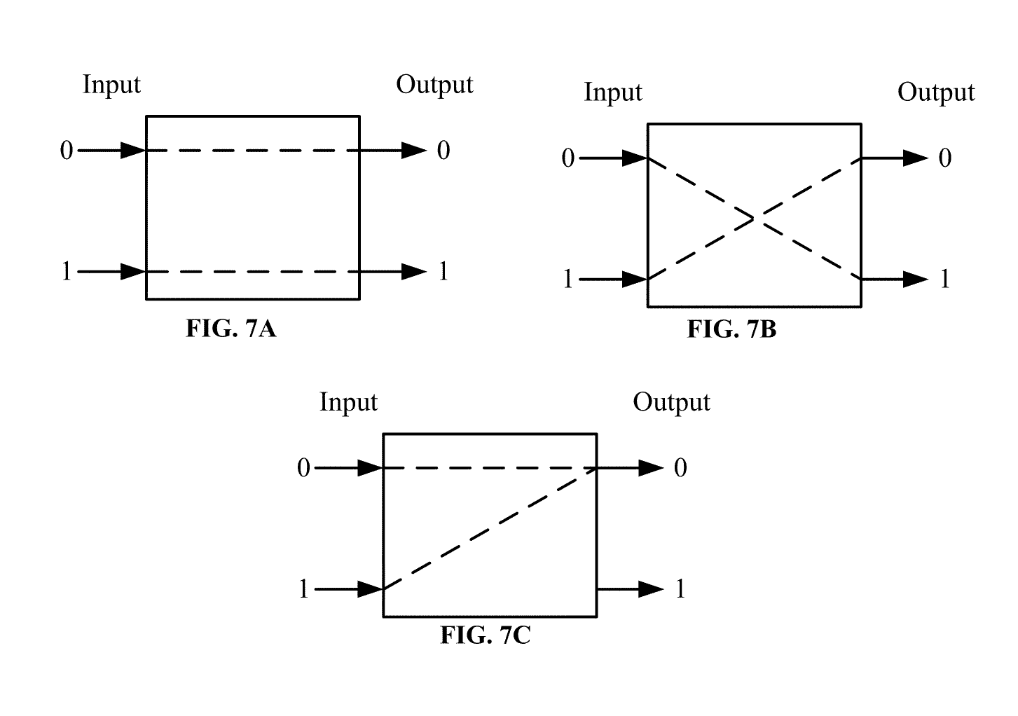

As shown in FIGS. 7A, 7B, and 7C, the embodiment of the invention of a basic self-routing unit and a method for building its half-cleaners, sorters, network concentrators and multicast switching network is based on the network shown in FIGS. 7A, 7B, and 7C, and further gets other devices or units used in the network by setting or establishing a basic self-routing unit, thus acquiring the multicast switch network of the embodiment. FIGS. 7A, 7B, and 7C are based on the completely distributive self-routing model of the group theory multistage interconnection network [Wei He, Hui Li, Bin-qiang Wang; “Load-Balanced Multipath Self-routing Switching Structure by Concentrators”, IEEE Proc. of ICC2008, May, 2008] and adopts a divide-and-conquer network [S.-Y. R. Li, Hui Li; “Layout complexity of bit-permuting exchange in multi-stage interconnection networks”, book chapter in Switching Networks: Recent Advances, Kluwer Academic Publishers, Boston, USA, pp. 259-276, 2001] which has the characteristic of high modularity and lowest device complexity (N log₂N). The following table 1 is the model description when N=64, 256, 1024, 4096. In the following Table 1, “:” represents the one-stage 2×2 unit. The connecting wire between two stages is represented by one digit permutation group element, for example, (6 3) (5 2) (4 1). Numerals represent the subscripts of sources and target binary addresses, for example, S₁S₂S₃S₄ and d₁d₂d₃d₄. FIGS. 7A, 7B, and 7C represent the model when N=64. (Note: N means that all 2ⁿ-scale networks have their corresponding divide-and-conquer networks.) The following table describes permutation group models of a plurality of divide-and-conquer networks of different scales.

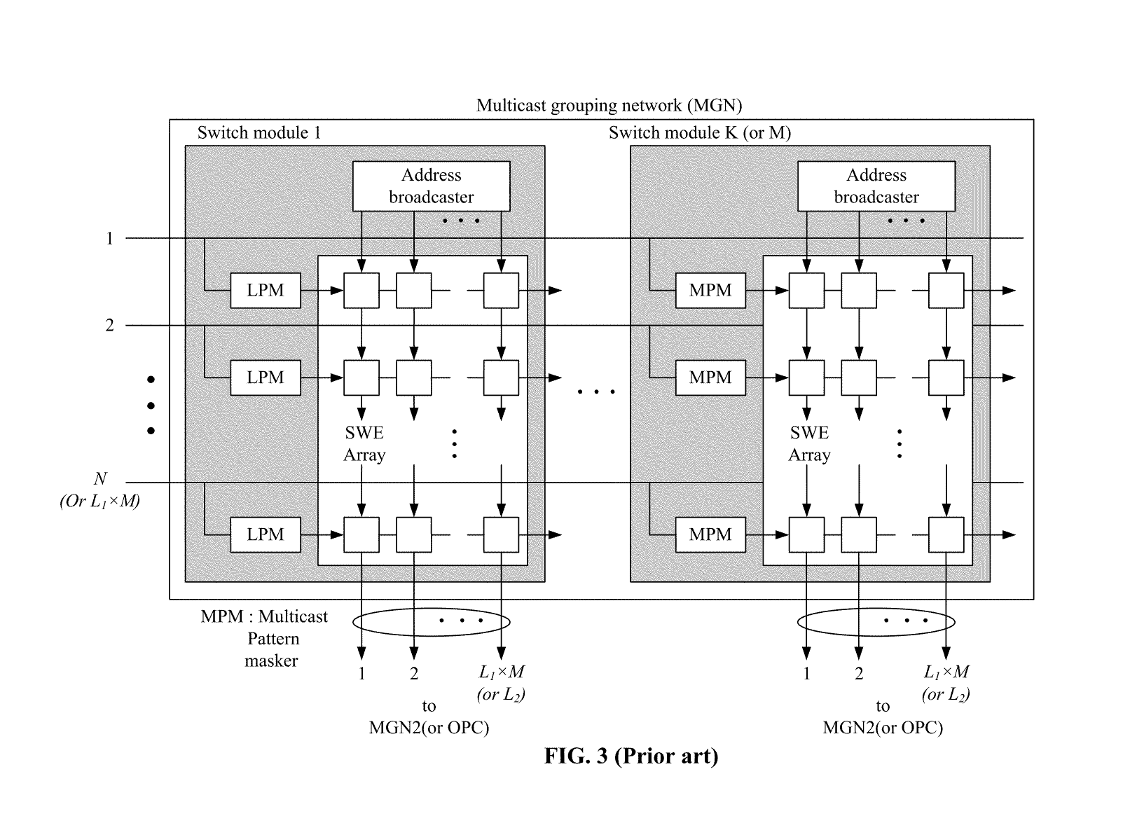

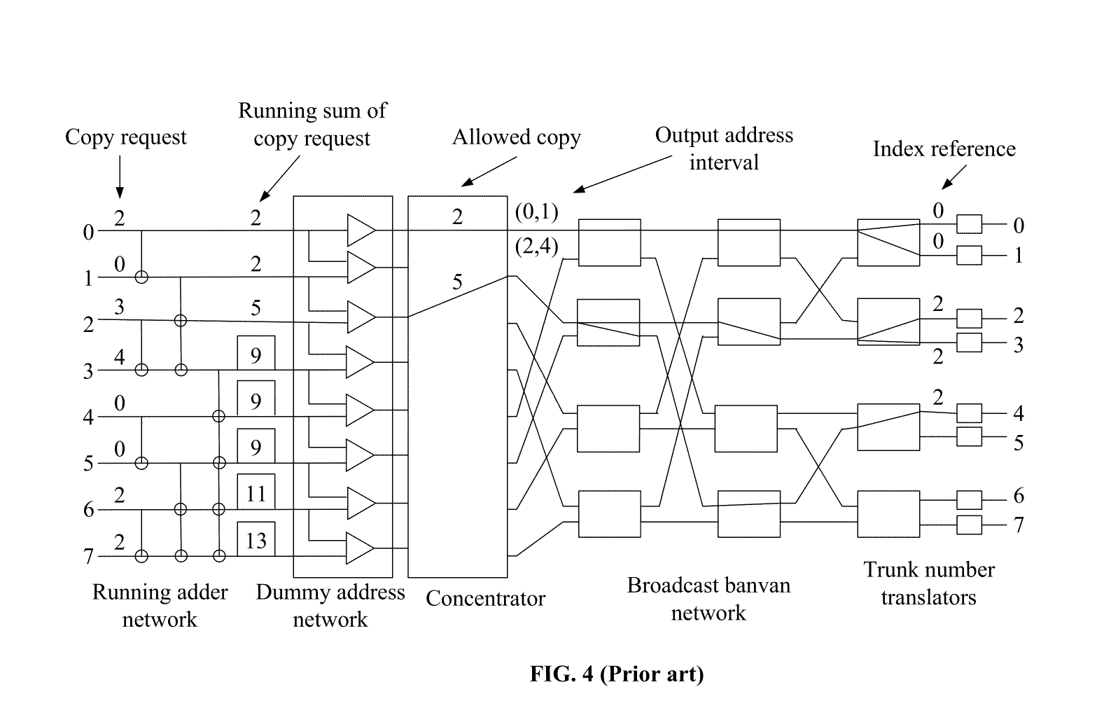

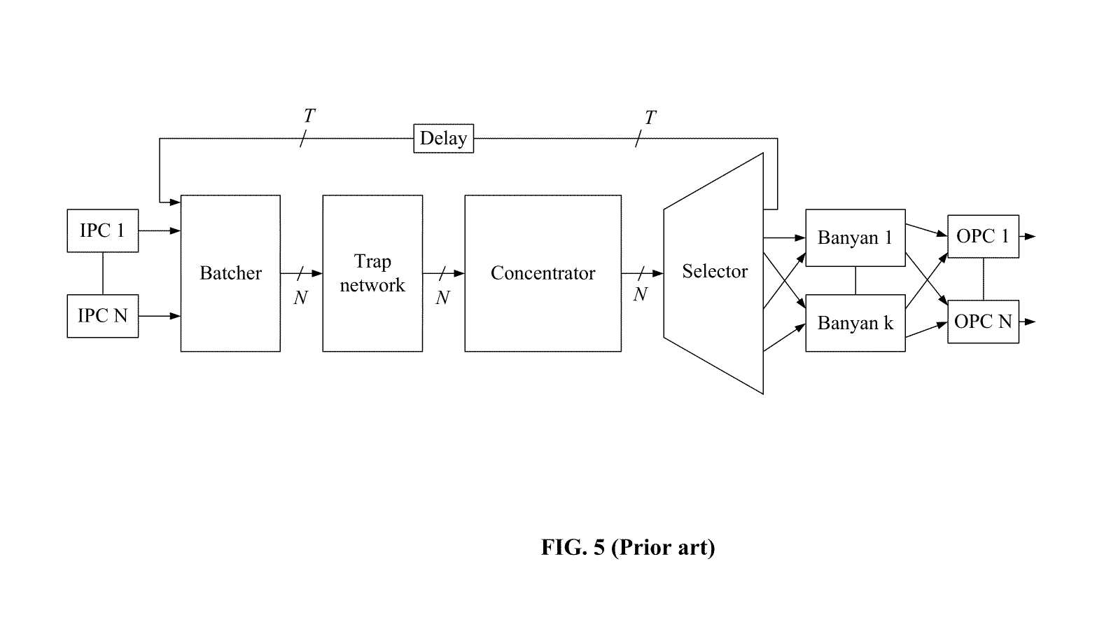

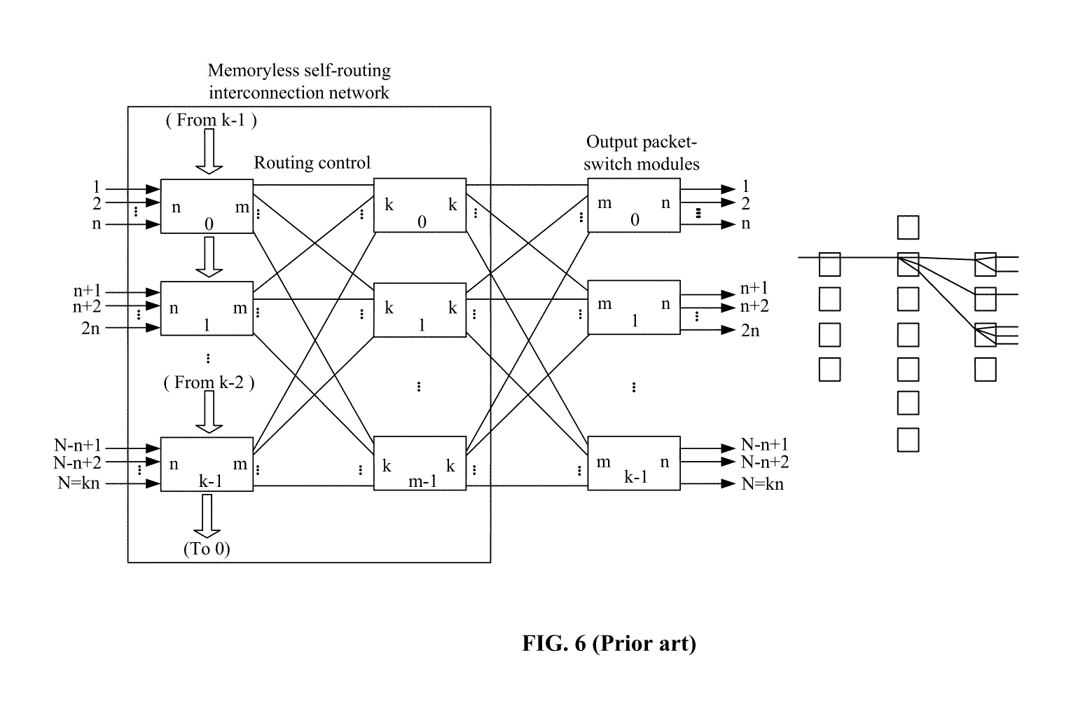

TABLE 1

| | |
|---|---|
| 64 × 64: | [id:(6 5):(6 5 4):(6 3)(5 2)(4 1):(6 5):(6 5 4):id]; (as |
| | shown in the FIG. 3.1) |
| 256 × 256: | [id:(8 7):(8 6)(7 5):(8 7):(8 5)(7 3)(6 2)(5 1):(8 7):(8 |
| | 6)(7 5):(8 7):id]; |
| 1024 × 1024: | [id:(10 9):(10 9 8):(6 9 7 10 8):(10 9):(10 5)(9 4)(8 3)(7 |
| | 2)(6 1):(10 9):(10 9 8):(6 9 7 10 8):(10 9):id]; |
| 4096 × 4096: | [id:(12 11):(12 11 10):(12 9)(11 8)(10 7):(12 |
| | 11):(12 11 10):(12 6)(11 5)(10 4)(9 3)(8 2)(7 1): |
| | (12 11):(12 11 10):(12 9)(11 8)(10 7):(12 11):(12 |
| | 11 10):id]; |

In a divide-and-conquer network, the data packet sort switch process of a 2×2 basic self-routing sort element can be realized by using in-band signaling, for example, adding two-digit in-band signaling before the data packet. The first digit A₁ active bit represents whether the current time slot has a data packet or not, which is represented by 1 or 0, wherein 1 represents that there is an active effective data packet and 0 represents an empty packet that now has effective data. Further, when A₁ is 1, the second digit D₁ represents that the output target port address of the packet is 0 or 1. Further, when A₁ is 0, D₁ is meaningless. Accordingly, A₁D₁ equals to “10”, “11” and “00” which respectively represent the effective data packet whose output port target is 0, the effective data packet whose output port target is 1 and the empty data packet.

Therefore, during unicast, a 2×2 network basic element can realize self-route according to the prescribed linear sort relation as follows: 10<00<11, the specific control mode of the unicast 2×2 network basic element by two-digit in-band signaling self-routing switch sees the following table.

| Connection | | Input Port 1 In-band Signaling A₁D₁ | | |
|---|---|---|---|---|
| Status | | “10” | “00” | “11” |
| Input Port 0 | 10 | Contend for output | Parallel | Parallel |
| In-band | | 0, choose cross or | | |
| Signaling | | parallel randomly or | | |
| A₁D₁ | | according to some | | |
| | | mechanism | | |
| | 00 | Cross | Without input | Parallel |
| | | | packets, | |
| | | | choose cross | |
| | | | or parallel | |
| | | | randomly | |
| | 11 | Cross | Cross | Contend for |
| | | | | output 1, |
| | | | | choose cross or |
| | | | | parallel |
| | | | | randomly or |
| | | | | according |
| | | | | to some |
| | | | | mechanism |

According to the fast knockout [S.-Y. R. Li, Hui Li; “Optimization in the fast knockout algorithm for self-route concentration”, IEEE Proceedings of ICC'98, pp. 630-634, Atlanta, June 1998] concentrator construction algorithm or bitonic circular [S.-Y. R. Li; Algebraic Switching Theory and Broadband Applications, Academic Press, 2001], the element can constitute any 2G-to-G self-routing group concentrators by coordinating with the one-stage half-cleaner [Hui Li, S.-Y. R. Li; On the Complexity of Concentrators and Multi-stage Interconnection Networks in Switching System, The Chinese University of Hong Kong, 2000.11].

In the embodiment, in order to realize the full combination of multicast and unicast, the target multicast is realized by the wire speed fan-out copy at the physical data link layer, wherein the physical data link layer needs to build a basic multicast circuit unit. Generally, an ideal structure of a switch fabric is that it can realize recursive extension of scale at will, has no bottleneck, and is a large-scale switch system built by the most fundamental 2×2 element at the lowest cost through various topological structure and meets performance indexes.

Obviously, the unicast 2×2 basic self-routing element doesn't have the quality required by multicast. Therefore, the embodiment builds a 2×2 basic self-routing element which meets the multicast conditions, namely a basic 2×2 sorter, and gets a large-scale switch system through the unit.

Two output tabs are 0 and 1, when the sorter is used for the 2×2 unicast switch fabric. The route unit means defining of packet route. An effective packet includes a route signal and its following load. The value of the signal is either 0-bound or 1-bound, depending on its own target output. The null value of the signal is represented as idle. In the embodiment, the corresponding self-routing in-band signal table of the route unit is represented as Ωᵣₒᵤₜₑ={ 0-bound, 1-bound, idle}, wherein the 0-bound=10, 1-bound=11 and idle=00. Therefore, the original linear sort of 10<00<11 equals the sequence prescribed as follows: 0-bound<idle<1-bound.

Linear sort operation is carried out to transmit effective signals as much as possible to their predetermined output ports. The selection of straight/cross status depends on packet priority when the output contention of two 0-bound packets or two 1-bound packets happens.

In order to support the 2×2 sorter of wire speed multicast, the unit with functions shown in the table below must be provided, wherein FIGS. 7A, 7B, and 7C, shows part status. FIGS. 7A, 7B, and 7C represent that 2×2 basic self-routing sort elements of unicast are in states of parallel, cross and contention. As you see, when multicast is input, it represents that the aim of load delivery is the bicast signal of the two ports 1 and 0. Further, when the bicast signal meets the idle signal, a newly increased core function is able to realize wire speed fan-out copies of two packets while transporting the copies to output ports 0 and 1. In the text, “ [symbol] ” represents disjunction of Boolean algebra; and “ [symbol] ” represents conjunction of Boolean algebra. The function of the 2×2 multicast sorter that supports the wire speed fan-out of multicast is shown in the table below:

| Connection status of | | | | | |
|---|---|---|---|---|---|
| multicast switch | | Input signaling information of 0 input port | | | |
| sorter | | 0 | 1 | B | I |
| Input | 0 | Contention | Cross | Cross | Cross |
| signaling | | output | | | |
| information | | port 0 | | | |
| of 1 input | 1 | Parallel | Contention | Parallel | Parallel |
| port | | | output port 1 | | |
| | B | Parallel | Cross | Cross/ | Multicast |
| | | | | parallel | copy |
| | I | Parallel | Cross | Multicast | Cross/ |
| | | | | copy | parallel |

One can understand that the self-routing in-band signal table that supports multicast must be extended as Ω_{bicast}=Ωᵣₒᵤₜₑ∪{bicast}.

The extension set Ω_{bicast} is sorted by the rule 0-bound<idle<1-bound and the rule 0-bound<bicast<1-bound for their respective parts. The multicast unit sorts the signals that belong to the set Ω_{bicast}. However, when idle meets bicast, the switch control complies with the following rules: the output signal value of the output-0 port is 0-bound; the output signal value of the output-1 is 1-bound; and they are both followed by the same load.

Further, when going through the multicast unit, the packet load can be in a direct connection state, a cross state or a multicast mode with one input port connecting with two output ports. According to the mode, the multicast unit will transmit packet load to its predetermined target port as much as possible.

In order to combine the sort rules (two) and the switch rule, the signal table Ω_{bicast} must be given an algebraic lattice structure. The lattice is a set that has binary operand Boolean sum (“ [symbol] ”) and Boolean product (“ [symbol] ”) and complies with the following properties:

1) commutative law: a [symbol] b=b [symbol] a, a [symbol] b=b [symbol] a

2) associative law: a [symbol] (b [symbol] c)=(a [symbol] b) [symbol] c, a [symbol] (b [symbol] c)=(a [symbol] b) [symbol] c

3) idempotent law: a [symbol] a=a=a [symbol] a

4) absorption law: a [symbol] (a [symbol] b)=a=a [symbol] (a [symbol] b)

The common lattice is a subset of the set that follows the union and intersection operations in the Boolean operation. According to the rule of a≦b [symbol] a [symbol] b=a, one can see that every lattice can export a part ordered sequence. If any two elements of a part ordered set (referred to as poset for short) have an infimum and a supremum, the poset is called a partially ordered lattice. The Boolean sum and the Boolean product are used to represent the two limits and the poset has characteristics of lattices. On the other hand, every poset which is defined by a lattice is naturally a partially ordered lattice. Therefore, the partially ordered lattice equals to a lattice logically.

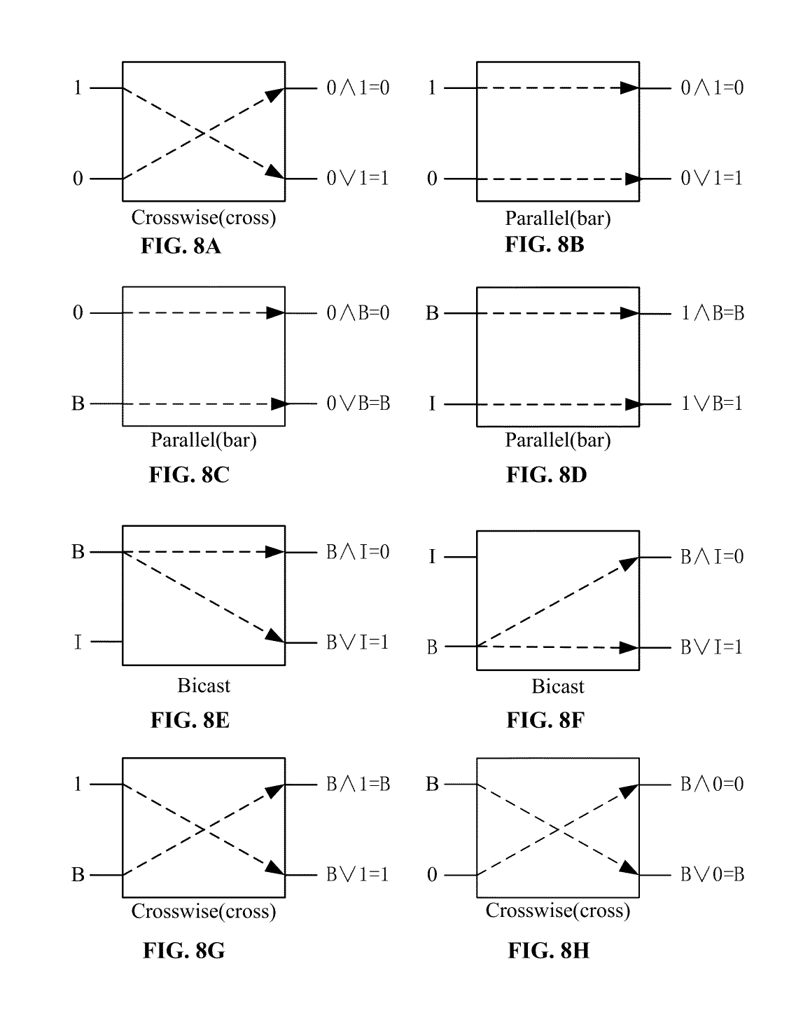

According to the sort rules, FIGS. 8A, 8B, 8C, 8D, 8E, 8F, 8G, and 8H describe part sorting of Ω_{bicast}, which jointly stipulate the connection of the high smaller element and the low larger element. As can be noticed, the partially ordered set Ω_{bicast} has quality of partially ordered lattice, so it is called a lattice. Then, the three rules of multicast unit operation (2 sort rules and 1 switch rule) can be integrated into the following Boolean rule: the value of 0 output port is the Boolean product of two input values, and the value of 1 output port is the Boolean sum of two input values.

If a lattice meets the distributive law:

a [symbol] (b [symbol] c)=(a [symbol] b) [symbol] (a [symbol] c),

a [symbol] (b [symbol] c)=(a [symbol] b) [symbol] (a [symbol] c)

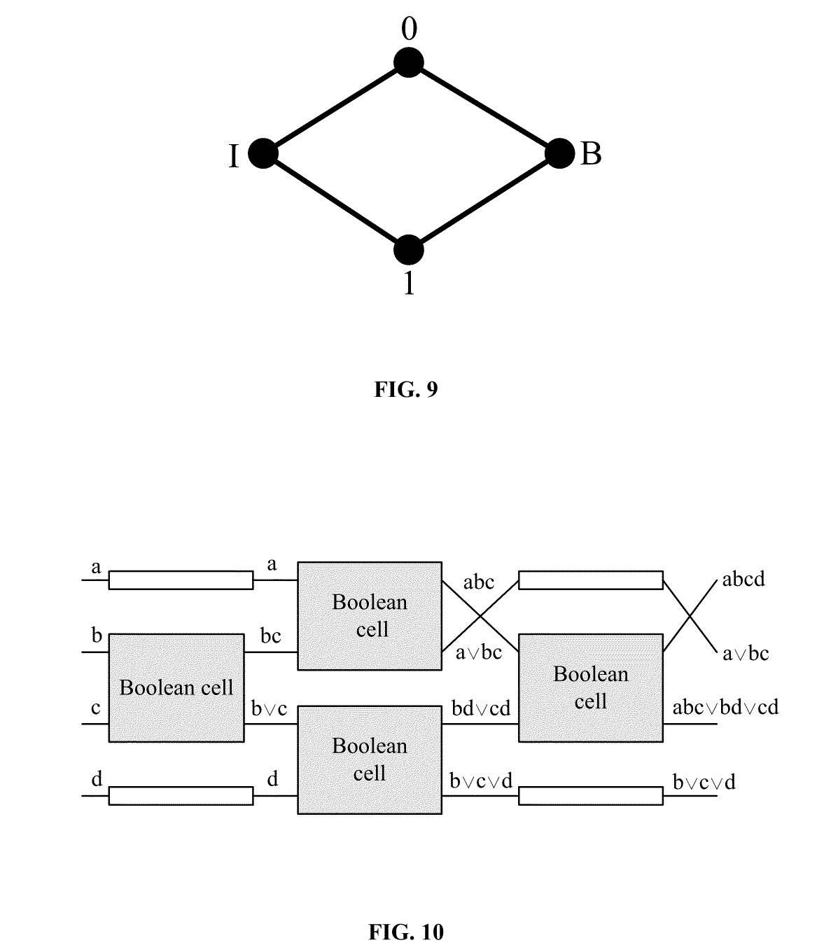

the lattice is a distributive lattice. Ω_{bicast} is a simple example. Referring to FIG. 9, it represents the partially ordered set that connects the high smaller element and the low larger element. The partially ordered set Ω_{bicast} has characteristics of lattice poset so it can be regarded as a lattice. Actually, a distributive lattice can act as a signal table of multicast unit. Therefore, sometimes, the multicast unit is called a Boolean unit.

To sum up, the embodiment builds a basic self-routing unit for multicast which includes two input ports and two output ports. The input ports includes a first input port and a second input port (the 0 input port and the 1 input port), and the output ports are respectively a first output port and a second output port (the 0 output port and the 1 output port). The input signal of the input ports comprises the route signal and the following data attribute (the data attribute comprises the data priority field that shows the priority of the data) and data content. The route signal has the algebraic lattice structure. The route signal includes a bicast signal, a unicast signal and an idle signal. The route signals of the two input ports are the bicast signal and the idle signal respectively. The input port whose route signal is the bicast signal is connected with the first output port and the second output port respectively. The output route signal value of the first output port is the Boolean product of the two input route signals. The output route signal value of the second output port is the Boolean sum of the two input route signals. The input route signals of the two input ports both point to one of the two output ports. The two input ports contend for the pointed output port according to the data priority of the data attributes of their input signals. The input port with higher data priority is connected with the output port and the input port with lower data priority is connected with the other output port. The input route signals of the two input ports point to different output ports respectively. The input ports are connected with the output ports crosswise or in parallel. The cross connections include the connection of the first input port and the second output port and the connection of the second input port and the first output port. The parallel connections include the connection of the first input port and the first output port and the connection of the second input port and the second output port. In the embodiment, the route signals have the algebraic lattice structure, which includes using the algebraic lattice to build the self-routing in-band route signal table, and the algebraic lattice is distributive lattice.

In the embodiment, according to the above description, it is easy to get the sorting with the hierarchy of the following algebraic structure: ordered set [symbol] distributive lattice [symbol] lattice [symbol] poset. In the embodiment, the distributive lattice is used to build the self-routing in-band signal table of multicast sort and multicast switch. Up till now, what the common switch fabrics use were all linear ordered sets, especially when the signal value is represented by numerals.

The requirement for carrying out complete sorting of all in-band signals not only limits the application scope of the structure, but even worse completely blocks the multicast operation. The same is very clear in the light of the comparison between the 2×2 multicast unit based on the distributive lattice and the original 2×2 unicast unit.

Pay attention to the importance of the distributive law. The distributive lattice can customize special applications, for example, adding multicast of QoS features. For instance, all five axioms of conjunctive normal form based on supporting the distributive lattice. The general sorting 0-1 theory is introduced in the reference S.-Y. R. Li; Algebraic Switching Theory and Broadband Applications, Academic Press, 2001, and needs the same axiom basis with the conjunctive normal form. On the other hand, when all original signal values are not completely ordered, the signal table is usually built into a poset structure. However, mathematical tools which derive from the axioms that dominate posets or even partially ordered lattices are not enough for the multicast switch.

FIG. 10 clearly illustrates the importance of the distributive lattice, which shows a 4×4 three-stage Boolean sorting network constituted by 2×2 Boolean sorters and interstage synchronous 1×1 time delay units. The four input values a, b, c and d belong to arbitrary distributive lattices. In FIG. 10, the exporting of 4 output expressions which is linearly increased from top to bottom is applied to the distributive law. If there is no distributive law, the top output value can only be expressed as abc ((b [symbol] c)d) rather than abcd.

The distributive law is equally important to the Boolean concentrator theorem. More evidences and intuitions show that the distributive lattice is a natural, proper, perfect choice in the building of multicast switch fabrics and the hierarchy of algebraic sorting, in light of the cost complexity of device realization and the application probability and flexibility.

The embodiment also comprises half-cleaners, sorters and network concentrators through the basic self-routing unit. The network units are all obtained through different topology and recursion of the basic self-routing unit. The specific description is provided below.

Generally, the 2×2 bitonic sorter can transmit two input port signals to the combinational logic circuit of the output port after self-routing sorting based on the size of the signals, according to one digit address information. A bitonic sequence is a sequence which only includes a plurality of 0 and 1. Their sequences may progressively increase before decreasing progressively, or progressively decrease before increasing progressively, or monotone increasing or monotone decreasing. (The sequences like 0 . . . 01 . . . 10 . . . 0 or 1 . . . 10 . . . 0111, 0 . . . 01 . . . 1, 1 . . . 10 . . . 0 are all bitonic sequences.)

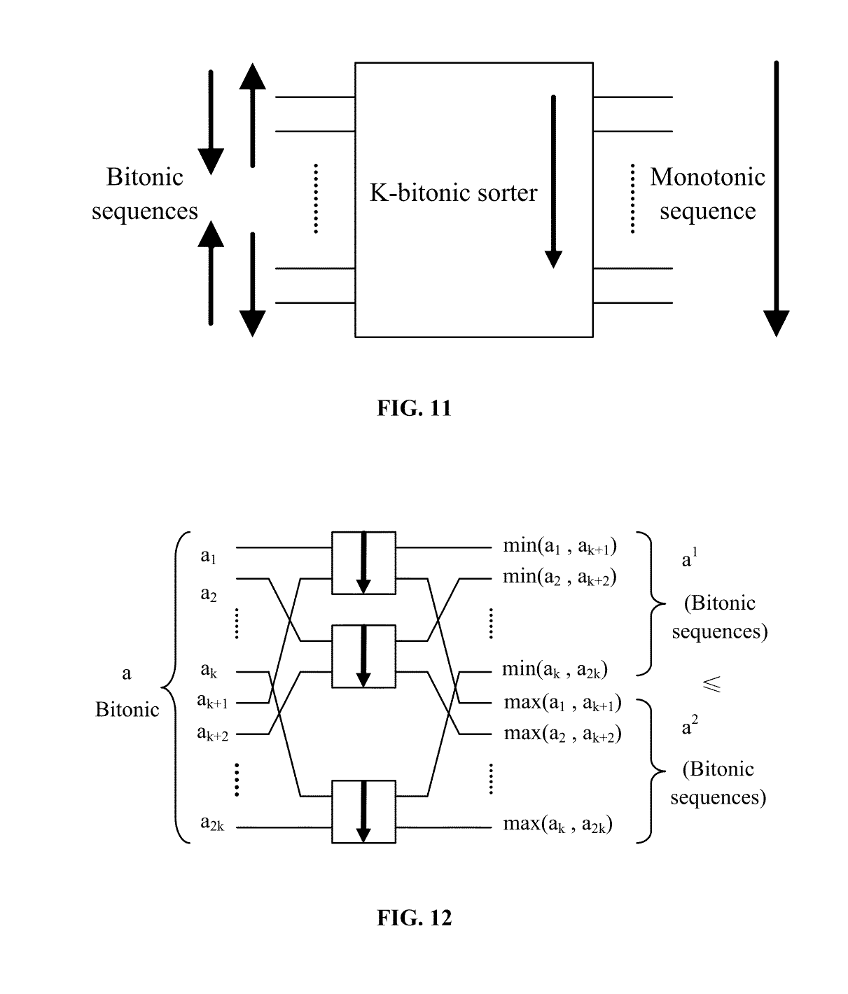

A k-bitonic sorter is a network that can sort a bitonic sequence at the length of k into a monotonic sequence. As shown in FIG. 11, the output port data is arranged from small to large in the direction of arrows. That is to say, the k-long bitonic sequence, of which monotone increasing connects monotone decreasing or monotone decreasing connects monotone increasing, can be sorted into a k-long monotone increase linear 0 . . . 01 . . . 1 sequence.

A k-half-cleaner is a primary network which can divide a 2k-long bitonic sequence into 2 bitonic sequences a₁ and a₂, and can ensure a₁≦a₂. The definition of the operator ≦ is as follows: as for the two bitonic sequences of equal length a₁ and a₂, if every element of a₁ sequence is less than or equal to elements of a₂, a₁≦a₂. It should be noted that not all bitonic sequences have such relation. Only when one of the sequences to be compared is all 0 or all 1, such relation exists. For example, 000000≦001100, 111100≦111111. In the embodiment, the specific structure of the k-half-cleaner is shown in FIG. 12. The k 2×2 bitonic sorters are arranged in order, and the 2×2 bitonic sorter includes two input ports and respectively transmits the one with the smaller input signal value to the low output port and the one with the larger input signal value to the high output port. One input port of the n^{th} one of the k bitonic sorters is the n^{th} input port of the half-cleaner, and the other input port is the (k+n)^{th} input port of the half-cleaner. The low output port of the n^{th} one of the k bitonic sorters is the n^{th} output port of the half-cleaner, and its high output port is the (k+n)^{th} output port of the half-cleaner. The first output port to the k^{th} output port of the half-cleaner outputs a bitonic sequence a₁, and the (k+1)^{th} output port to the 2k^{th} output port of the half-cleaner outputs a bitonic sequence a₂, a₁≦a₂, wherein, k is a positive integer and n=1, 2, . . . k. Further, the 2×2 bitonic sorter is the basic self-routing unit.

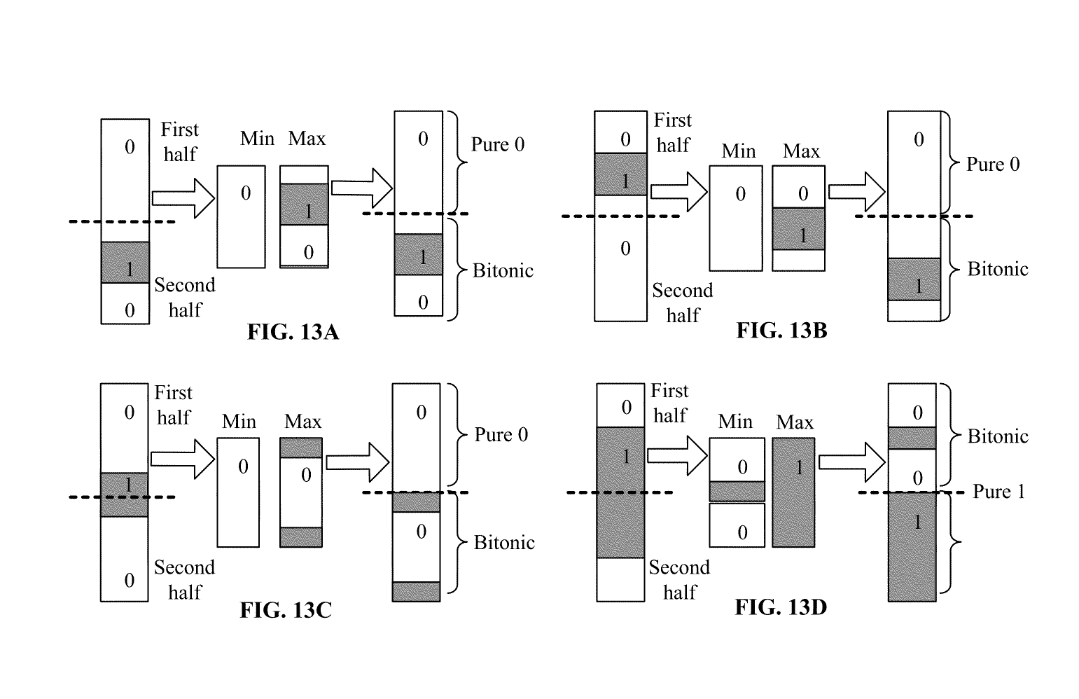

The bitonic sequence a₁ . . . a₂ₖ with a defined length of 2k only has two situations 0ⁱ1^{j}0^{m} or 1ⁱ0^{j}1^{m}. i+j+m=2k, wherein i, j and m are numerals which range from 0 to 2k. Just prove 0ⁱ1^{j}0^{m} through symmetry. As shown in FIGS. 13A, 13B, 13C, and 13D, according to the sizes of i, j and m, the 2k sequence is divided into two parts equally. There four situations a/b/c/d as shown in FIGS. 13A, 13B, 13C, and 13D, constructive enumeration proof of which is also presented together. Firstly, the input sequence is divided into two parts, namely a first half and a second half: wherein, the “first half” represents the first half sequence a₁ . . . aₖ and the “second half” represents the second half sequence aₖ₊₁ . . . a₂ₖ; the “min” represents the min(aⱼ, aⱼ₊ₖ) sequence output after half-cleaner comparison; and the “max” represents the max(aⱼ, aⱼ₊ₖ) sequence output comparison.

Any two sequences constituted by 0 and 1 all constitute a 2-long bitonic sequence by themselves. Therefore, the half-cleaner of K=1 is an above stipulated 2×2 bitonic sorter whose output is already linear sorting.

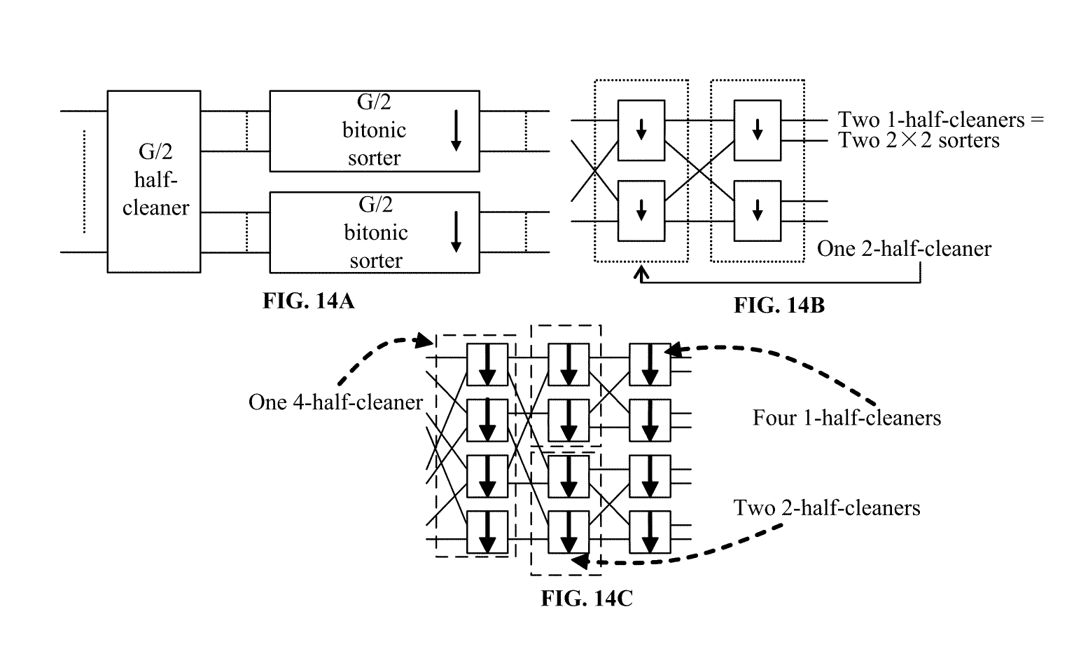

According to the definition and the half-cleaner structure, the following method can be used to input the bitonic sorter at a scale of G=2^{g} through recursive construction. The first stage is 1 half-cleaner of k=G/2, whose output is two bitonic sequences of G/2=2^{(g-1)}, and one of the bitonic sequences is already an identical 0 or 1 sequence. The second stage is 2 bitonic sorters of (G/2)×(G/2). The first stage of every (G/2)×(G/2) bitonic sorter is a half-cleaner of k=G/4, whose output is 2 bitonic sequences of G/4=2^{(g-1)}, and one of the bitonic sequences is already an identical 0 or 1 sequence. Therefore, the second stage outputs 4 G/4 bitonic sequences. The third stage is 4 (G/4)×(G/4) bitonic sorters. Based on such recursion, the g^{th} stage is 2^{(g-1)} 2×2 bitonic sorters, namely a half-cleaner of k=1. Therefore, as for g-stage half-cleaners that halve stage by stage, the amount of half-cleaners of each stage progressively increases by times. FIG. 14A shows a common recursive structure. FIG. 14B shows that a bitonic sorter of G=4 can be constituted by one 2-half-cleaner and two 2×2 sorters. FIG. 14C shows that a bitonic sorter of G=8 is constituted by one 4-half-cleaner and two 2×2 bitonic sorters of G=4. Therefore, in the embodiment, the bitonic sorter includes G input ports and G output ports, wherein G=2^{g} and g is a positive integer. The bitonic sorter includes g stages, and among them, the m^{th} stage includes of 2^{m-1} half-cleaners of k=G/2^{m}, wherein m=1, 2, . . . , g. Each stage of the half cleaners includes a plurality of 2×2 bitonic sorters, and the output port of each 2×2 bitonic sorter is respectively connected with the input ports of different 2×2 bitonic sorters of the half-cleaners of the next stage or with different half-cleaner input ports of the next stage.

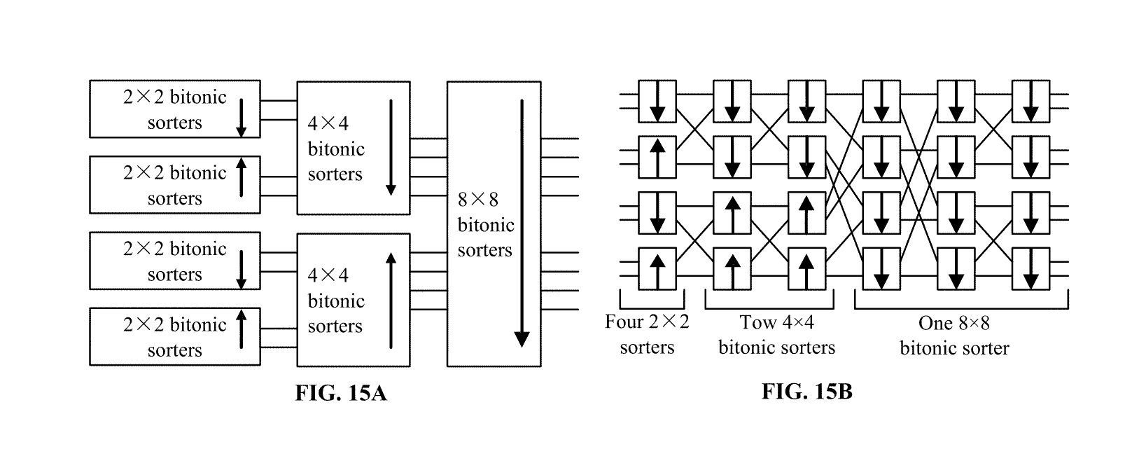

The recursion by bitonic sorter can be used for construction when G=2^{g} input signals are an arbitrary 0-1 binary sequence. The first stage is 2^{(g-1)} vertically stacked 2×2 bitonic sorters, namely 2×2 sorters. The second stage pairs the output signal of the first stage into 2^{(g-2)} bitonic sequences which are input to 2^{(g-2)} vertically stacked 4×4 bitonic sorters. Based on such recursion, the g^{th} stage pairs the output signals of the (g−1)^{th} stage into a G-long bitonic sequence, which is input to a G×G bitonic sorter. FIG. 15A represents the recursion construction process of an arbitrary 0-1 binary sorter of G=2³. FIG. 15B shows a detailed structure of an arbitrary 0-1 binary sorter of G=8. In the embodiment, an arbitrary binary sorter consists of G input ports and G output ports, and the g in the G=2^{g} is a positive integer. The arbitrary binary sorter comprises g-stage bitonic sorters, and, wherein, the p^{th} stage comprises 2^{g-p} G×G bitonic sorters of G=2^{p}; and the bitonic sorters are connected according to their stages.

A 2G-to-G concentrator refers to a 2G×2G sort switch module, which routes G maximum signals of 2G input signals to G output ports of the maximum output addresses and routes the other G signals to G output ports of the minimum output addresses. The network concentrator comprises 2G input ports and 2G output ports. The network concentrator comprises 2 G×G arbitrary binary sorters and half-cleaners of k=G which are connected with output ports of 2 G×G arbitrary binary sorters. G maximum sort output ports of the half-cleaners are a 1-output group. G minimum sort output ports of the half-cleaners are a 0-output group. Every output port of the network concentrator is strung with an address filtering unit.

The structure of a 2G-to-G concentrator is constituted by connecting a one-stage half-cleaner of k=G after 2 G×G arbitrary 0-1 binary sorter networks. Naturally, G maximum sort output ports can be regarded as a “1-output group”, and the other n small sort output ports are regarded as a “0-output group”. Since every input port at every time lot in the self-routing switch fabric may be idle and without data, or have data which are transmitted to the “1-output group”, or “0-output group”, there are at least three situations.

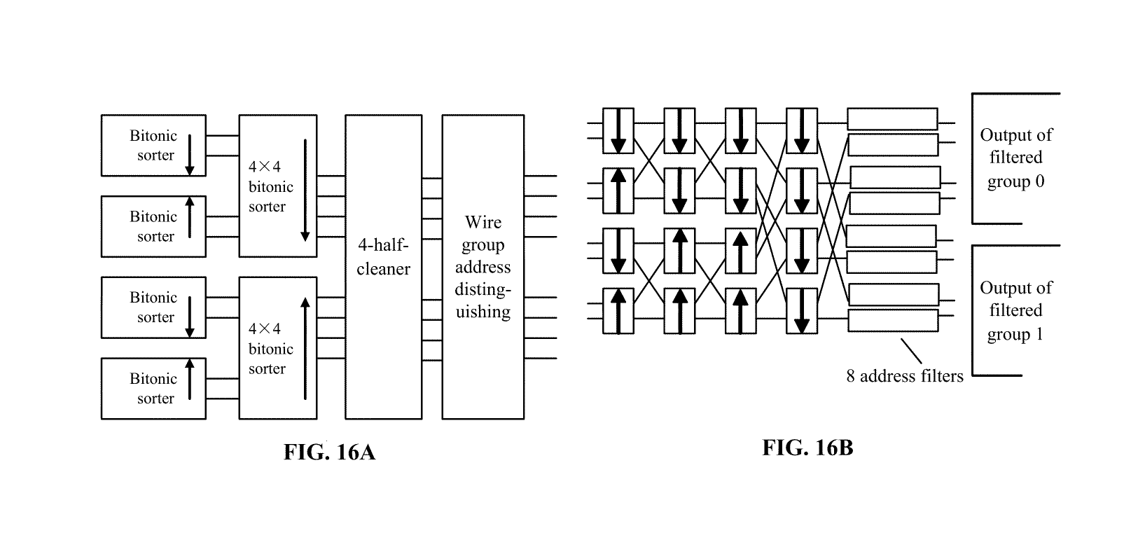

Although the above has been talking about sorters of 0-1 binary sequences, any sorters that can sort 0-1 sequences accurately can also sort sequences which are constituted by any numerals according to the “0-1” theorem. Therefore, the sorters of the structure can sort the two-digit information of the three input packet status. The sorting size is based on the 1-output group, the idle and the 0-output group. Therefore, if the number of packets which are transmitted to a certain group at each time slot exceeds G, the packets will be mistakenly self-routed to another group address, so that the packet addresses are identified after every group output line so as to block the packets whose destination addresses are mistakenly routed and leave correct route packets, at most G packets. FIGS. 16A and 16B are examples of a 2G-to-G self-routing group concentrator of G=4.

As for multicast, the multicast concentrator theorem refers to the n-to-m concentrator which is constituted by sorters of a multistage internetwork, and replaces sorters with multicast units. In order to make the signal table Ω_{bicast}, it would be well if V₀ input values are 0-bound, V₁ input values are 1-bound and are V_{B} input values are bicast. The following result can be gotten: n−m top output ports may produce min{n−m, V₀+V_{B}} 0-bound and bicast signals in total at most. m bottom output ports may produce min{m, V₁+V_{B}} 1-bound and bicast signals in total at most.

A Boolean network is a multistage internetwork, wherein all the nodes are Boolean units. Further, when the units constitute concentrators, every Boolean network equals to a multistage internetwork which is constituted by Boolean units.

When there is a proper multicast signal table Ω_{bicast}, the multicast concentrator theorem is in an input state, which can realize the optimal multicast switch. When Boolean units replace sorters of the concentrator network, the theorem is tenable for the signal table of any lattice or distributive lattice structure. This causes a question: what essential attributes of Ω_{bicast} lattice structures cause the multicast concentrator theorem? With careful observation, it is found that Ω_{bicast} is divided into a top ideal {0, B} and a bottom ideal {1, I} in Claim 7, and {1, B} and {0, I} in Cclaim 8 similarly.

If the nonvoid subset S of the lattice Ω meets the conditions of xεS, yεS=>x [symbol] yεS, x [symbol] yεS, S is a sublattice; if xεS, yεΩ=>x [symbol] yεS, the sublattice S is a top ideal; and if xεS, yεΩ=>x [symbol] yεS, the sublattice S is a bottom ideal.

If the Boolean operation of the mapping between two lattices remains unchanged, the mapping is called lattice homomorphism. The lattice homomorphism from the lattice Ω to the lattice Ω₂ is the same as dividing the lattice Ω into a top ideal and a bottom ideal.

A homomorphism μ of mapping from the lattice Ω to the lattice Ω₂ comprises partition of Ω: a top ideal μ⁻¹(0) and a bottom ideal μ⁻¹(1). Conversely, the lattice Ω is divided into a top ideal U and a bottom ideal L, and, if sεU, μ(s)=0 and sεL, μ(s)=1, is the homomorphism of lattices from Ω and Ω₂.

As for a n-to-m concentrator which is constituted by sorters of a multistage internetwork, Boolean units are used to replace all sorters of the multistage internetwork to then get a n-to-m Boolean concentrator network which is called a Boolean concentrator. An arbitrary distributive lattice Ω is divided into a top ideal U and a bottom ideal L. Input u values from the U, 0≦u≦n, after entering the concentrator network from n−u values of the L: the n−m top ports output min{n−m, u} which belongs to the value of the U; and the m bottom ports output min{m, n−u} which belongs to the value of the L.

According to the 0-1 theory of Boolean concentrators, the unit is a n-to-m Boolean concentrator. Make t represents the homomorphism of Ω and Ω₂ in sεU, μ(s)=0 and sεL, μ(s)=1. Use p(s) to replace every input signal s. This converts n input signal values into the combination of u 0 and n−u 1. According to the nature of the concentrator network, n−m top ports output min{n−m, u} 0 and n bottom ports output min{m, n−u} 1. Because t is a lattice homomorphism, the interstage is replaced with the same signals. When the output value of a output port is 0 or 1 after the replace, the output value before replace respectively belongs to μ⁻¹(0)=U or μ⁻¹(1)=L.

As for the n-to-m concentrator which is constituted by a multistage internetwork of sorters, all sorters are replaced with bicast units, so when the signal table is Ω_{bicast}, one of the following declarations is tenable:

The output of n−m top ports is only 0-bound signals. The output of m bottom ports is only 1-bound signals. No output of ports is idle signals, and no output of ports is bicast signals.

The abbreviations for signal values 0-bound, 1-bound, bicast and idle are respectively 0, 1, B and I. The accurate input combination of the multistage internetwork which is constituted by bicast units is: V₀ 0, V₁ 1, V_{B} B and V_{I} I. Due to the special characteristics of the signal table, the bicast unit of the multistage internetwork will be further replaced with Boolean units. Therefore, the Boolean concentrator theorem can be used and ensure the building of the Boolean concentrator network.

Now, it will be divided into the top ideal U={0, B} and the bottom ideal L={I, 1}. In order to assess the initial symmetric polynomial σₘ₊ᵢ of n variables of n-units:
(1) if V₁+V₂≧m+1, the value of σₘ₊₁ is either 1 or I, because some monomials of σₘ₊₁ only relates to the variables whose value is 0 or B among the n variables; and
(2) if V₁+V₂≦m+1, the value of σₘ₊₁ is either 0 or B, because some monomials of σₘ₊₁ only relates to the variables whose value is 0 or B among the n variables.

The other situation is to divide the ideal into the top part U={1, B} and the bottom part L={0, I}. The following conclusion is drawn in a similar way:
(3) if V₁+V₂≧m+1, the value of σₘ₊₁ is either 1 or B; and
(4) if V₁+V₂≦m+1, the value of σₘ₊₁ is either 0 or I.

If (2) and (4) are tenable, the value of σₘ₊₁ may only be 0, so that the standpoint that the output of n−m top ports is only 0-bound signals is tenable.

Symmetrically, if (1) and (3) are tenable, the value of σₘ₊₁ may only be 1, so that the standpoint that the output of m bottom ports is only 1-bound signals is tenable.

If (2) and (3) are tenable, the value of σₘ₊₁ may only be B, so σₘ≧σₘ₊₁=B. The output of n−m top ports can't be I. Therefore, the output of m bottom ports also can't be I. Therefore, the standpoint that no output of ports is idle signals is tenable.

According to symmetrical characteristics, when (1) and (4) are tenable, the standpoint that assumes that no output of ports is bicast signals is also tenable.

Therefore, the sum of 0-bound and bicast signals is reserved stage by stage in the multistage internetwork, so does the sum of 1-bound and bicast signals. Therefore, if any of the 4 statements related to the n-to-m concentrator which is constituted by a multistage internetwork of sorters is tenable, the statement should be regarded as a detailed version of the Boolean multicast concentrator theory. Actually, the version demonstrates a more common fact that: the Boolean concentrator theory can not only route signals as many as possible to the destination output group, but realize optimal routing according to their priorities. The concept of “priority” needs to be explained because the signal table is just an unordered set which is assumed to be a distributive lattice. The definition is suitable for all possible modes for dividing the distributive lattice into a top ideal and a bottom ideal. See the following examples for explanation.

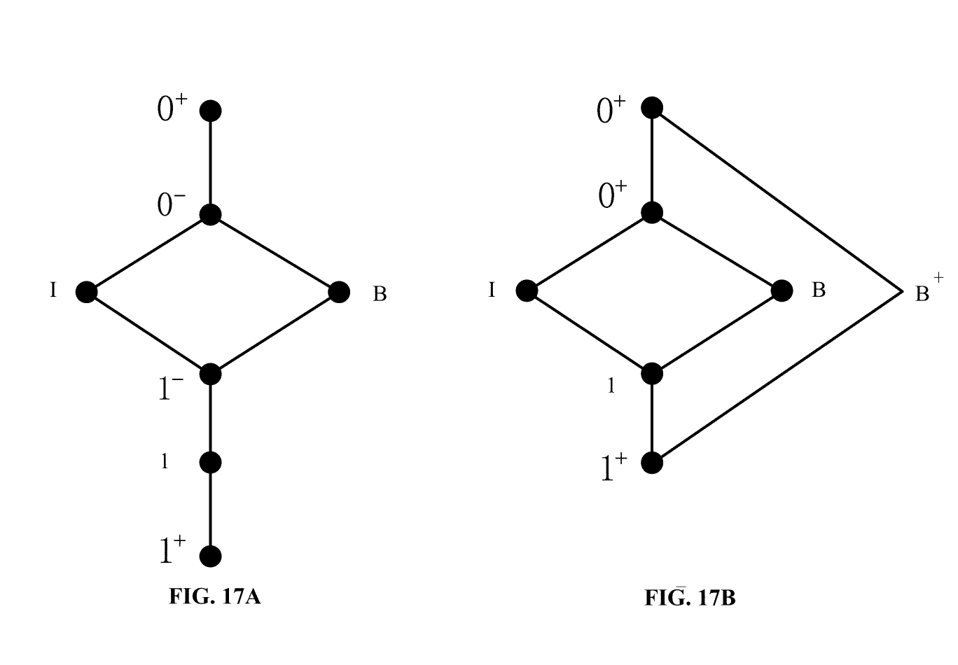

FIG. 17A shows a distributive lattice with a priority multicast signal table. The lattice shown in FIG. 17B is not a distributive lattice due to (I [symbol] B⁺) [symbol] 1=1≠I=(I [symbol] 1) [symbol] (B⁺ [symbol] 1). If Ω={0⁺, 0⁻, I, B, 1⁻, 1, 1⁺} is the distributive lattice in FIG. 17A, the naming rule of elements in Ω is that: the superscript “+” means the highest priority of arriving at the expected concentrator destination address 0 or 1; and “−” represents the lowest priority. The priorities of all route signals in Ω through an n-to-m Boolean concentrator involve all possible top ideal U sets and bottom ideal L sets which are obtained by dividing Ω. The sets are as follows:
U={0⁺}; L={0⁻, I, B, 1⁻, 1, 1⁺}
U={0⁺, 0⁻, I}; L={B, 1⁻, 1, 1⁺}
U={0⁺, 0⁻, B}; L={I, 1⁻, 1, 1⁺}
U={0⁺, 0⁻, I, B, 1⁻}; L={1, 1⁺}
U={0⁺, 0⁻, I, B, 1⁻, 1}; L={1⁺}.

According to the Boolean concentrator theorem, when signals are routed to the output group 0, the priority of any element of U is higher than the priority of any element of L, so does the route output group 1. The following conclusion can be drawn by applying the theory to the 5 dividing methods:
(5) Among the signals in the ordered subset {0⁺, 0⁻, I, B, 1⁻, 1, 1⁺}, the smaller elements of the signals towards the output group 0 are granted a higher priority, but the signals towards the output group 1 are granted a higher priority. The routing optimality of Boolean concentrators is consistent with the priority strategy.
(6) The similar priority method can be applied to the ordered subset {0⁺, 0⁻, I, B, 1⁻, 1, 1⁺}.

(7) Meanwhile, when being routed to any output groups, the two signals B and I are granted the same priority. That means that B and I can't appear in opposite output groups.

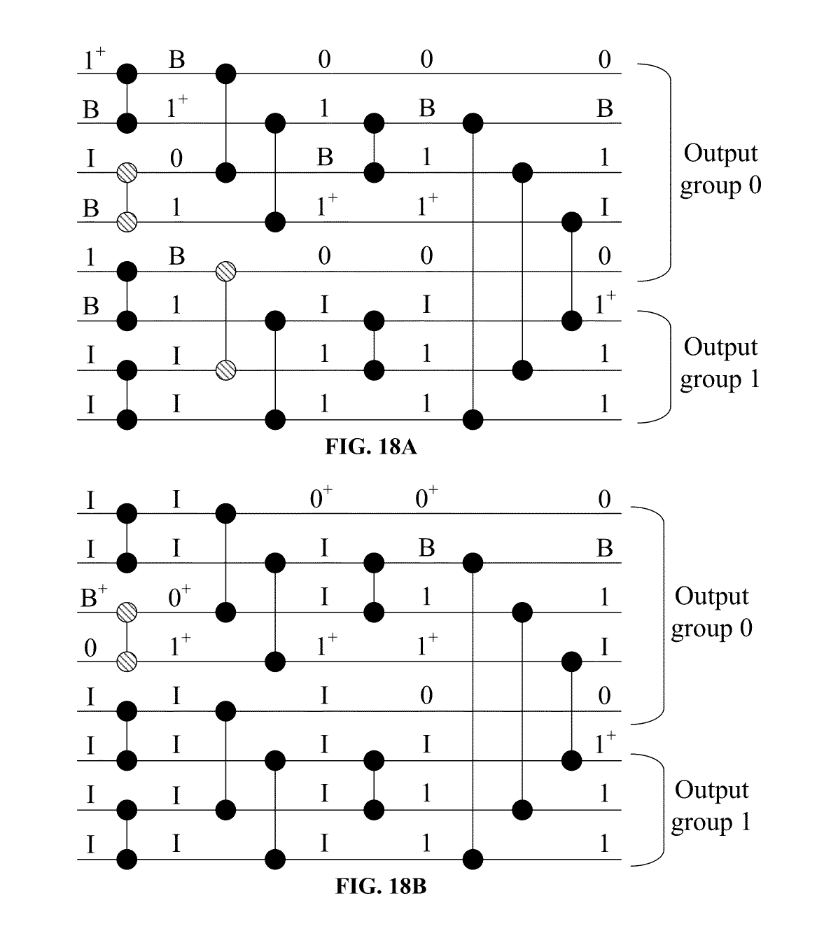

FIGS. 18A and 18B show a practical concentrator, wherein, FIG. 18A shows the 8-to-3 concentrator of the Boolean concentrator theory. The signals with a superscript “+” have the highest priority. When the signal table of FIG. 18B is the non-distributive lattice in FIG. 17B, the ideal switch can't be guaranteed. FIG. 18A illustrates the transmission process of signals from the distributive lattice Ω through an 8-to-3 Boolean concentrator network. 0, 1, B and I respective represent 0-bound, 1-bound, bicast and idle. The rounds of shaded parts in the drawing represent multicast signals. Here bicast and idle signals are replaced with 0-bound and 1-bound signals. Then, the output of the output group 0 is the largest one among the sum of 0-bound and bicast signals, but the output of the output group 1 is the largest one among the sum of 1-bound and bicast signals. In addition, the routing optimality is consistent with (5) and (7).

For example, FIG. 18B illustrates the transmission process of signal values of the non-distributive lattice Ω={0⁺, 0⁻, I, B, 1⁻, 1, 1⁺} in FIG. 17B through the same 8-to-3 Boolean concentrator network. Since B⁺ [symbol] I=0⁺ and B⁺ [symbol] I=1⁺ in the lattice, a bicast signal of high priority meets an idle signal in a Boolean unit and outputs 0-bound and 1-bound signals of high priority. However, the result is that only one effective signal appears in the output group 0. Did the input signal meet an idle signal at 1 stage by another mode (a bicast signal of high priority) and switch? It should also have two effective signals in the output group 0. The suboptimal routing result reflects that distributive lattice signal tables are essential in defining Boolean switches, concentrators and sorters.

Although non-distributive lattices are used as signal tables in practical application, the Boolean concentrator theory can still be applied when the multicast communication of high priority accounts for a very small part of the whole communication traffic.

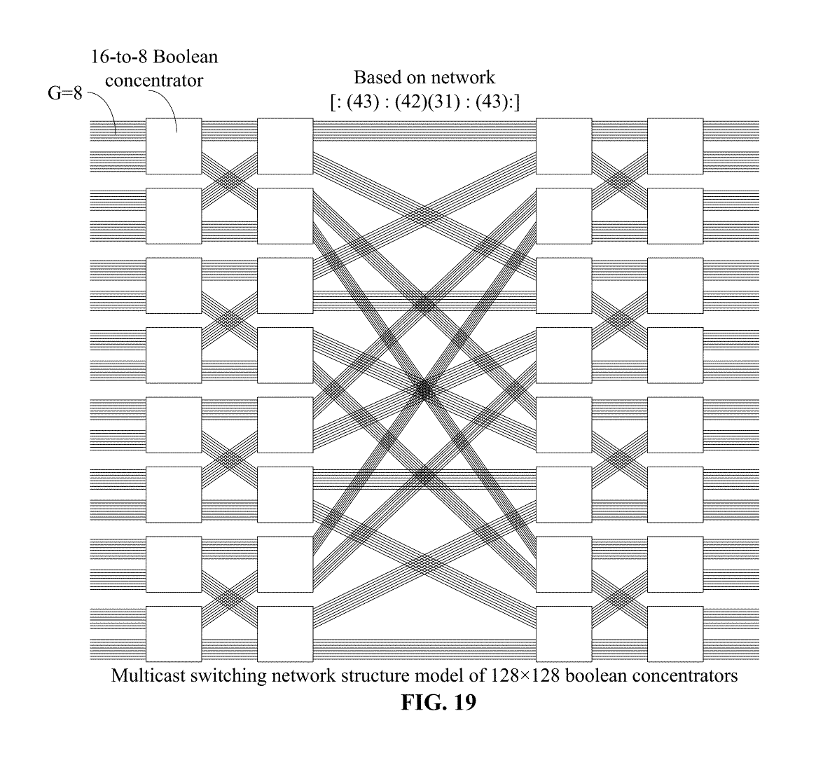

The complete self-routing divide-and-conquer network of high modularity and low device complexity can provide basic network structure models for the super large wire speed multicast routing switch fabrics of the study. In order to apply to large-scale multicast switching, a method for building large-scale and almost non-blocking switch fabrics is to apply the “statistical wire group” technology to the divide-and-conquer network. Every 2×2 node of the self-routing divide-and-conquer network is amplified as a 2G×2G node which is replaced with a fast knockout concentrator of 2G-to-G; in the network, every connecting wire is replaced with a bundle of G lines, thus building a multipath self-routing structure with statistical multiplexing characteristics. Every bundle of G output lines share a G-bit address. The packet loss ratio caused by communication fluctuations and burst decreases in an exponential order, with the increase of G value. For example, FIG. 19 is a multipath routing switch fabric of N=128, M=16 and G=8. The fabric is realized by replacing every 2×2 node of the 16×16 banyan network with a 2G-to-G Boolean concentrator which is constituted by Boolean sorters. Here G=8 but G should be a large number in practical use. Therefore, a 2n×2n banyan-type network of G-line version builds an N×N almost non-blocking multicast exchanger. According to the fast knockout concentrator construction algorithm or bitonic circula and the one-stage half-cleaner, any G can be built into a group concentrator of all sizes. In the embodiment, the network structure is built as follows: build a self-routing structure network that uses a divide-and-conquer network structure with optimal layout complexity. The self-routing structure network includes a plurality of 2×2 route units and the connecting wires between them. Use the network concentrators to replace the 2×2 route units and use wire harnesses with G wires to replace every connecting wires. Obtain an N×N multicast switching network which has M output groups and each group includes G output ports. Wherein, G represents groups; a bundle of G wires is recorded as a group; generally, the value is a large one; M represents the number of groups; and N represents the total number of the input/output wires of the multicast switching network, N=M*G.

In FIG. 19, N=128, M=16, G=8, the MSC is built by combining concentrators and routed networks. Generally, if N=2ⁿ, N=M×G, M=2^{m}, G=2^{g}, build an M×M routed network first (usually choose a divide-and-conquer network of optimal layout complexity). Then, replace the 2×2 route units of all stages in the network with 2G-to-G self-routing Boolean multicast concentrators. Then, an N×N multicast switching network which has M output groups and each group includes G output ports is built, as shown in FIG. 21.

The embodiment puts forward a multicast switch fabric based on algebraic lattice wire speed packets. The fabric has the following characteristics: the multicast switch fabric has characteristics of modularity and low component complexity and there are recursive extension models which are supported by mathematical theories; multicast is realized by the wire speed fan-out copy of physical data links, which features low time delay and no jitter; multicast strives to provide high-quality QoE and QoS for users rather than completely non-blocking videos; there are no bottlenecks of resource bandwidth and computational capability. Allow control algorithms to decide users' requirements for joining multicast or for access through possible assess. Give up port scheduling of every cell time slot.

The embodiments are only several modes of execution of the invention, which are relatively specific and detailed descriptions. However, the embodiments can't be interpreted as the limitation of patent claims of the invention. It should be noted that ordinarily skilled persons of the field can also make a plurality of changes and improvements within the concept of the invention. The changes and improvements are all within the scope of protection of the invention. Therefore, the scope of patent protection of the invention should be subject to the claims.

What is claimed is:

1. A basic self-routing unit for multicast, comprising:
two input ports comprising a first input port and a second input port; and
two output ports comprising a first output port and a second output port;
wherein:
an input signal of the input ports comprises a route signal and data attribute and data content;
the route signal comprises an algebraic lattice structure and comprises a bicast signal, a unicast signal and an idle signal; when the route signals of the two input ports are the bicast signal and the idle signal respectively, the input port whose route signal is the bicast signal is connected with the first output port and the second output port, the output route signal value of the first output port is a Boolean product of the two input route signals, and the output route signal value of the second output port is a Boolean sum of the two input route signals.

2. The basic self-routing unit for multicast of claim 1, wherein:
when the input route signals of the two input ports both point to one of the two output ports, the two input ports contend for the pointed output port according to data priority of the data attributes of their input signals, the input port with higher data priority is connected with the output port to which the input route signals are pointing and the input port with lower data priority is connected with the other output port; and
when the input route signals of the two input ports point to different output ports respectively, the input ports are connected with the output ports crosswise or parallelly; wherein:
cross connections comprise connection of the first input port and the second output port, and the connection of the second input port and the first output port; and
parallel connections comprise connection of the first input port and the first output port, and the connection of the second input port and the second output port.

3. The basic self-routing unit for multicast of claim 2, wherein the route signals comprise and use the algebraic lattice structure to build a self-routing in-band route signal table, and the algebraic lattice is distributive lattice.

4. A half-cleaner constituted by basic self-routing units of claim 3, wherein:
k 2×2 bitonic sorters are arranged in order, and the 2×2 bitonic sorter comprises the two input ports and respectively transmits the one with the smaller input signal value to the 0 output port, and the one with the larger input signal value to the 1 output port;
one output port of an nth one of the k bitonic sorters is a nth input port of the half-cleaner, and the other output port is the (k+n)th input port of the half-cleaner;
the low output port of the nth one of the k bitonic sorters is the nth output port of the half-cleaner, and its high output port is the (k+n)th output port of the half-cleaner;
the first output port to the kth output port of the half-cleaner outputs a bitonic sequence a1, and the (k+1)th output port to the 2kth output port of the half-cleaner outputs a bitonic sequence a2, a1≦a2; wherein, k is a positive integer, n=1, 2, . . . , k; and the 2×2 bitonic sorter is the basic self-routing unit.

5. The half-cleaner of claim 4, wherein when k=1, the half-cleaner is the basic self-routing unit.

6. A bitonic sorter constituted by the half-cleaner of claim 5, wherein:
the bitonic sorter comprises G input ports and G output ports;
G=2g and g is a positive integer; the bitonic sorter comprises g stages; among the g stages, the mth stage comprises 2m−1 half-cleaners of k=G/2m, wherein m=1, 2, . . . , g; and
each stage of the half cleaners comprises a plurality of 2×2 bitonic sorters, and the output port of each 2×2 bitonic sorter is respectively connected with the input ports of different 2×2 bitonic sorters of the half-cleaners of the next stage or with different half-cleaner input ports of the next stage.

7. An arbitrary binary sorter constituted by the bitonic sorters of claim 6, wherein:
the arbitrary binary sorter comprises G input ports and G output ports, G=2g wherein g is a positive integer; and
the arbitrary binary sorter comprises g-stage bitonic sorters and among the g stages, the pth stage comprises 2g-p G×G bitonic sorters of G=2p; and the bitonic sorters are connected according to their stages.

8. A network concentrator constituted by arbitrary binary sorters of claim 7, wherein:
the network concentrator comprises 2G input ports and 2G output ports;
the network concentrator comprises two G×G arbitrary binary sorters and half-cleaners of K=G which are connected with the output ports of the two G×G arbitrary binary sorters;
G maximum sort output ports of the half-cleaners are a 1-output group; and
G minimum sort output ports of the half-cleaners are a 0-output group.

9. The network concentrator of claim 8, wherein every output port of the network concentrator is strung with an address filtering unit.

10. A method for using the network concentrators of claim 9 to build a multicast switching network comprises:
a) building a self-routing structure network that uses a divide-and-conquer network structure with lower layout complexity, wherein the self-routing structure network comprises a plurality of 2×2 route units and connecting wires between them;
b) using the network concentrators to replace the 2×2 route units and using wire harnesses with G wires to replace every connecting wires; and
c) obtaining an N×N multicast switching network which has M output groups, wherein each group comprises G output ports;
wherein, N represents the total number of the input/output wires of the multicast switching network, N=MG.
